(19) United States
(12) Patent Application Publication
(10) Pub. No.: US 2019/0256950 A1
(43) Pub. Date: Aug. 22, 2019

(54) PROCESS FOR METAL RECOVERY IN FLOTATION OPERATIONS

(71) Applicant: PASSAU S.A., Talagante (CL)

(72) Inventors: Franziskus Horn, Talagante (CL); Francisco Horn, Talagante (CL); Pedro Horn, Talagante (CL)

(21) Appl. No.: 16/281,381

(22) Filed: Feb. 21, 2019

(30) Foreign Application Priority Data
Feb. 21, 2018 (CL) 00471-2018

(51) Int. Cl. C22B 15/00; B03D 1/002

(52) U.S. Cl. CPC C22B 15/0008; B03D 2201/02; B03D 2203/02; B03D 1/002

(57) ABSTRACT

The present invention is related to a process for increasing copper or metal recovery in flotation processes, specially of minerals that are dissolved during the grinding stage, by the use of any sulfidizing agent or ionizing sulfide such as, but not limited to, sodium hydrogen sulfide, sodium sulfide, potassium hydrogen sulfide, potassium sulfide, ammonium hydrogen sulfide or ammonium sulfide, hydrogen sulfide (H2S), polysulfides of potassium, calcium, magnesium or ammonium to precipitate during the grinding stage or immediately after the grinding stage, metals that have been dissolved prior or during the milling or grinding stage prior to normal flotation.

### CROSS-REFERENCE TO RELATED APPLICATIONS

The present application claims priority to Chilean Patent Appl. No. 00471-2018, filed Feb. 21, 2018, and incorporates its disclosure herein by reference in its entirety.

### TECHNICAL FIELD

The invention relates to the recovery of metals through flotation processes, more particularly flotation of sulfide minerals, where easily soluble minerals are present, which are lost in traditional flotation processes.

### BACKGROUND

Traditionally there have been two ways to process minerals to recover metals from ores.

If the ore is a metal oxide ore, recovery has been through leaching, then solvent extraction and electro winning, obtaining pure copper cathodes.

If the ore is a metals sulfide mineral, traditionally the recovery has been through grinding, froth flotation to obtain a sulfide concentrate, followed by pyrometallurgical purification.

In recent years some hydrometallurgical processes have been developed, where sulfide minerals can also be processed through leaching and electro winning, specially using bacterial leaching of copper sulfides or alkaline leaching of sulfide minerals.

The main problem some mines face are that they have a combination of sulfides and oxides and so they have to decide if they process the mixture through flotation, increasing the oxide losses or process through hydrometallurgical leaching, where they lose some of the sulfide content.

There are several existing mineral flotation processing plants that are fed with sulfide minerals mixed with oxides, or sulfides that have been oxidized in its surface and that therefore cannot be recovered in normal flotation processes.

In some cases “sulfidization” is an important tool to improve recovery of some of the oxides during sulfide froth flotation. In this case, a sulfidizing agent such as sodium hydrogen sulfide, sodium sulfide or polisulfides of different metals is added during froth flotation or just before the milled mineral pulp is fed into the flotation cells, in order to modify the surface of the oxides or sulfide minerals with surface oxidation, to allow the sulfide collectors to attach to the mineral surface and cause the mineral particles to be hydrophobic, so that they can be recovered by normal sulfide flotation.

The advantage of this process is that it allows recovering important amounts of metal that otherwise would be lost, without need of investing in new plants and equipment, since the only difference to traditional flotation is that the sulfidizing agent is added to the process.

Normally, in case of sodium hydrogen sulfide, doses of about 80 g/ton of mineral or −60 to −100 mV Redox potential have to be achieved to obtain best results.

If the reagent is overdosed, a negative result is obtained, since the same reagents at higher doses have an effect as depressant, which causes the metal to be recovered not to float and be lost in the tailings.

For example, copper flotation plants that use the addition of sodium hydrogen sulfide prior or during flotation, can see improvements from 2% to 8% in their copper recovery.

In most of the copper minerals, there are also pyrite minerals present. In order to obtain a clean concentrate without iron contamination, lime is added into the flotation process to increase pH value to a point where pyrite is depressed or does not float and is lost to the tailings. This pH value is normally around 8 or 9.

For the depression of pyrite, lime is added normally during the milling stage of the flotation process and in some cases then topped up during flotation stages.

Most of the flotation plants therefore float their minerals at pH values around 8 to 9 and also grind them at pH values of 7 to 9.

These pH values above 7 also have shown to reduce the consumption of steel during grinding.

The traditional sulfidization, where sodium hydrogen sulfide is added during the flotation process, takes care of some minerals that are oxidized on the surface and cannot be recovered by traditional collector reagents.

But this known process does not solve a major loss in the industry, which are the minerals that are easily soluble, even without addition of an acid.

It has been observed that minerals like chalcanthite (CuSO₄·5H2O), or brochantite (Cu₄(SO₄)(OH)₆) are normally lost in traditional flotation circuits.

It has been also observed that atacamite Cu₂Cl(OH)₃ minerals are easily dissolved during grinding. For example a mineral from the Region de Atacama in Chile, containing 0.41% atacamite mineral, when analyzed after grinding, the atacamite content had diminished to only 0.18%.

Some other plant feeds, like minerals coming from old tailings, that still have a high copper content, enough to be processed, have a natural pH value of about 5, condition at which part of the metal is present as soluble metal sulfate.

In one tailings processing plant in Chile, where water jets are used to recover the deposited tailings, the copper sulfates are dissolved even prior to grinding and lost after the addition of lime precipitates copper as hydroxide.

In most of the copper processing plants, lime is added during the grinding stage to depress pyrite. If this happens, the dissolved copper is precipitated as metal hydroxide, and as metal hydroxide said metal is then not recovered in the flotation process, even if a sulfidizing agent is added to the flotation after this precipitation occurs.

On the other hand, when metal cations, like for example copper cations, are available during the grinding stage, an increased consumption of steel is observed, since the copper cations dissolve the steel from the mill and balls. Therefore, plants need to use large amounts of lime to precipitate the dissolved metals as metal hydroxides, and in this way to reduce steel consumption during grinding.

Additionally, the presence of dissolved copper in the grinding stage increases the activation of pyrite, causing difficulties in further depression with lime and thus resulting in poor grade concentrates due to the high content of pyrite.

The U.S. Pat. No. 1,483,270 A describes the process of sulphidation to increase copper recovery by floating ores of a non-sulfide nature.

The U.S. Pat. No. 4,008,072 A describes a process in which an alkaline sulfide is added in a specially designed reactor into an acid leaching pulp to precipitate sulfides and recover them through flotation. This patent also indicates that sulfidization is “highly successful in the processing of some ores, such as lead ores”, but “sulfidization has been of limited utility in connection with copper ores”

Patent DE 3690783 C2 describes a process of concentration of copper oxide mineral by flotation involving pre-sulphidation with molten sulfur.

BRIEF SUMMARY OF THE INVENTION

It was discovered that if a ionizing sulfide or sulfidizing agent such as, but not limited to, sodium hydrogen sulfide, sodium sulfide, potassium hydrogen sulfide, potassium sulfide, ammonium hydrogen sulfide or ammonium sulfide, hydrogen sulfide (H₂S), polysulfides of potassium, sodium, calcium, magnesium or ammonium, is added to the grinding stage without adjusting the pH with lime or only slightly adjusting the pH with lime to values around 7 during the grinding stage, the dissolved metal, such as copper, molybdenum, silver, or others, can be precipitated forming a metal sulfide, which as sulfide then has an affinity for the collector reagents used in the flotation and therefore can be recovered in the traditional flotation process, without need of modifying the existing plant.

One additional advantage of the addition of a sulfide precipitating agent is that the content of dissolved copper is reduced or eliminated and so, the consumption of grinding steel is eliminated by the metal cation corrosion.

After the grinding has been completed and the dissolved metal has been precipitated in the pulp, the mineral pulp continues to the normal flotation process plant, where additional flotation reagents, such as lime, collectors or frothers can be added as if it would be a traditional flotation process.

The dose of the sulfidizing agent has to account for the stoichiometric amount of metal that will be dissolved in the process and has to be adjusted to each mineral condition, plus losses that naturally will occur according to oxidation of the sulfurizing agent. In some cases, the dose of reagent could be less than the stoichiometric relation or could be higher than the stoichiometric relation to the dissolved metal. The electrochemical potential should be preferably between −100 mV to −200 mV, in some cases between −50 mV to −250 mV. If the Potential is too negative, a depressing effect will be achieved.

Just as an example, but not limited to the case of use of sodium hydrogen sulfide in presence of copper sulfate is shown in following formula:

CuSO₄+NaHS→CuS+NaHSO₄

One of the advantages of this process, similar to the sulfidization described as state of the art, is that no modifications to the normal plant layout have to be adopted or additional expenses other than the addition of the sulfidizing agent have to be paid.

As an example, for one kg of copper, 0.88 kg of stoichiometric sodium hydrogen sulfide has to be added, whereas the copper has a value of about 6 times the reagent used. This means that the cost of the additionally recovered metal, in case of copper, is only about 15% of the recovered value.

In addition to the previously mentioned advantages, the elimination of metal cations has a positive effect as a reduction of activation of pyrite minerals. It is known that dissolved metal cations increase the activation of pyrite, which increases the difficulty and depresses pyrite in the flotation process. Therefore, the addition of a precipitant, such as the sulfidizing agent, will eliminate the source of activation of pyrite and thus reduce the consumption of lime or the addition of sodium bisulfite used in some processing plants to reduce the effect of pyrite activation.

It has been seen that in laboratory grinding tests in a typical mineral from northern Chile, 5 percent of the copper is contained as oxide mineral, whereas after grinding, the content of oxide mineral has dropped to 2,5 percent, where the rest of the oxide mineral has been dissolved and passed to the aqueous phase.

In case of H₂S generation during the addition of the sulfidizing agent, the agent can be added after grinding but before flotation in an enclosed mixing reactor or mixing device, where H₂S emissions can be captured and controlled.

### DETAILED DESCRIPTION OF THE INVENTION

The present invention is carried out by a process that comprises adding a ionizing sulfide or sulfurizing agent in the grinding step or in a prior step, so as to precipitate as insoluble sulfides the dissolved metal ions of interest or being dissolved in the grinding step prior to flotation, in order to recover them by a conventional flotation process.

In a preferred embodiment, the ionizing sulfide or sulfidizing agent is selected form the group comprising sodium hydrogen sulfide, sodium sulfide, potassium hydrogen sulfide, potassium sulfide, ammonium hydrogen sulfide or ammonium sulfide, hydrogen sulfide (H₂S), polysulfides of potassium, sodium, calcium, magnesium or ammonium or a mixture of thereof.

In another preferred embodiment, during grinding, the pH is adjusted with lime or another modifying agent to a pH of 6.0 to 8.0 or more preferably to 6.5 to 7.5 during the grinding stage, to neutralize the generation of acid caused by the precipitation reaction.

In another preferred embodiment, the pH is not adjusted during the grinding stage.

In another preferred embodiment, the sulfidizing agent is added after grinding but before the actual flotation and also prior to the addition of lime to adjust pH.

In a preferred embodiment, the dose of sulfidizing agent is such that the pulp will achieve an electrochemical potential of −50 mV to −250 mV, or more preferably of −100 mV to −200 mV.

In a preferred embodiment, the sulfidizing agent is added at a dose close to the stoichiometric rate of dissolved metal to obtain a floatable metal sulfide. This dose can be slightly below the stoichiometric or above the stoichiometric dose of dissolved metal.

In another preferred embodiment, in the subsequent flotation steps a sulfidizing agent dosage is maintained as well as a normal sulfidizing process so as to maintain an electrochemical potential allowing the precipitated sulfides to be recovered.

In a preferred embodiment, the metal to be recovered is copper.

In another preferred embodiment, copper minerals containing brocantite, chalcanthite and atacamite ore similar species are processed.

In a preferred embodiment of the invention, the ionizing sulfide or sulfidizing agent is added during the grinding step of the ores containing soluble metal minerals.

In another preferred embodiment of the invention, the ionizing sulfide or sulfidizing agent is added into an ore pulp containing sulfides, soluble sulfides and dissolved metals, such as mineral pulps recovered from tailings.

The present invention is further directed to a process for increasing selectivity in copper recovery in flotation operations due to reduction of activation of pyrite minerals, comprising the following steps:

adding a ionizing sulfide or sulfurizing agent in the step of grinding an ore containing soluble copper or an ore pulp containing sulfides or dissolved copper, besides pyrite;

grinding the mixture obtained in the previous step so that the dissolved copper precipitates immediately by conversion into insoluble sulfides, and avoids activation of pyrite; and

recovering the copper precipitated in the previous step with sulfides from the mineral by conventional flotation processes with sulfide collectors.

Lastly, the present application is also focused on a process for decreasing grinding steel consumption in flotation operations through the reduction in the presence of copper cations, which comprises the following steps:

adding a ionizing sulfide or sulfurizing agent in the step of grinding an ore containing soluble copper or an ore pulp containing sulfides and dissolved copper;

grinding the mixture obtained in the previous step so that the dissolved copper precipitates immediately by conversion into insoluble sulfides, and avoids dissolution of steel; and

recovering the copper precipitated in the previous step with sulfides from the mineral by conventional flotation processes with sulfide collectors.

### EXAMPLE

A mineral pulp obtained from an old tailings dam in central Chile containing about 0.3% copper and with a content of 50% solids was tested at laboratory conditions. The fraction of water contained 130 ppm Cu prior to grinding and the pH value of the pulp was 5.

A standard grinding with addition of lime and following flotation with collector and frother was performed obtaining a recovery of 62% of the contained copper. Flotation pH was 9.

Then, using the same grinding time with addition of lime during grinding, a flotation was performed adding sodium hydrogen sulfide prior to flotation at a dose of 80 g/ton, obtaining an EV of −80 mV. Under this condition, 72% of the copper was recovered. This would correspond to a traditional sulfidization process used normally at mine sites where oxide minerals are present.

A third test was made, adding sodium hydrogen sulfide at a dose of 80 g/ton to the mill and the amount of lime needed to adjust pH to 7. After grinding, a normal flotation with the same dose of collector and frother was performed at a pH of 9, adjusting pH with additional lime prior to flotation. Under these conditions, a copper recovery of 79% of the contained copper was obtained under laboratory flotation conditions.

The results show that the addition of the sodium hydrogen sulfide to the mill in the presence of a mineral pulp that also contains dissolved copper results in a significantly improved recovery of copper than the traditional sulfidization process, where the sulfidizing agent is added after the grinding stage.

What is claimed:

1. Process for improving recovery of metals in mineral flotation operations or metal mineral pulps containing easily soluble metal sulfides and/or metal oxides or metals in solution in the case of pulps from reprocessed tailings, characterized in that it comprises adding a ionizing sulfide or sulfurizing agent in the grinding step or in a prior step, so as to precipitate as insoluble sulfides the dissolved metal ions of interest or being dissolved in the grinding step prior to flotation, in order to recover them by a conventional flotation process.

2. The process according to claim 1, characterized in that the ionizing sulfide or sulfidizing agent is selected form the group comprising sodium hydrogen sulfide, sodium sulfide, potassium hydrogen sulfide, potassium sulfide, ammonium hydrogen sulfide or ammonium sulfide, hydrogen sulfide (H2S), polysulfides of potassium, sodium, calcium, magnesium or ammonium, or a mixture of thereof

3. The process according to claim 1, characterized in that the pH is adjusted with lime or another modifying agent to a pH of 6.0 to 8.0 or more preferably to 6.5 to 7.5 during the grinding stage, to neutralize the generation of acid caused by the precipitation reaction.

4. The process according to claim 1, characterized in that the pH is not adjusted during the grinding stage.

5. The process according to claim 1, characterized in that the sulfidizing agent is added after grinding but before the actual flotation, and also prior to the addition of lime to adjust pH.

6. The process according to claim 1, characterized in that the dose of sulfidizing agent is such that the pulp will achieve an electrochemical potential of −50 mV to −250 mV, or more preferably of −100 mV to −200 mV.

7. The process according to claim 6, characterized in that the sulfidizing agent is added at a dose close to the stoichiometric rate of dissolved metal to obtain a floatable metal sulfide.

8. The process according to claim 7, characterized in that the sulfidizing agent is added at a dose slightly below the stoichiometric dose of dissolved metal.

9. The process according to claim 7, characterized in that the sulfidizing agent is added at a rate slightly above the stoichiometric rate of dissolved metal.

10. The process according to claim 1, characterized in that in the subsequent flotation steps a sulfidizing agent dosage is maintained as well as a normal sulfidizing process so as to maintain an electrochemical potential allowing the precipitated sulfides to be recovered.

11. The process according to claim 1, characterized in that the metal to be recovered is copper.

12. The process according to claim 11, characterized in that copper minerals containing brocantite, chalcanthite and atacamite ore similar species are processed.

13. The process according to claim 1, characterized in that through the addition of a sulfidizing agent, a reduction in grinding steel consumption is obtained.

14. The process according to claim 1, characterized in that the ionizing sulfide or sulfidizing agent is added during the grinding step of the ores containing soluble metal minerals.

15. The process according to claim 1, characterized in that the ionizing sulfide or sulfidizing agent is added into an ore pulp containing sulfides, soluble sulfides and dissolved metals, such as mineral pulps recovered from tailings.

16. The process according to claim 1, characterized in that through the precipitation of copper in solution during the grinding step, pyrite activation is avoided.

17. The process according to claim 16, characterized in that through the precipitation of copper in solution, grinding steel consumption is reduced since the presence of copper in solution is avoided, which dissolves steel by electrochemical processes.

18. The process according to claim 16, characterized in that through the reduction in activation of pyrite minerals the selectivity in copper recovery is increased in flotation operations.

19. Process for increasing selectivity in copper recovery in flotation operations due to reduction of activation of pyrite minerals, characterized in that it comprises the following steps:
adding a ionizing sulfide or sulfurizing agent in the step of grinding an ore containing soluble copper or an ore pulp containing sulfides or dissolved copper, besides pyrite;
grinding the mixture obtained in the previous step so that the dissolved copper precipitates immediately by conversion into insoluble sulfides, and avoids activation of pyrite; and
recovering the copper precipitated in the previous step with sulfides from the mineral by conventional flotation processes with sulfide collectors.

20. Process for decreasing grinding steel consumption in flotation operations through the reduction in the presence of copper cations, characterized in that it comprises the following steps:
adding a ionizing sulfide or sulfurizing agent in the step of grinding an ore containing soluble copper or an ore pulp containing sulfides and dissolved copper;
grinding the mixture obtained in the previous step so that the dissolved copper precipitates immediately by conversion into insoluble sulfides, and avoids dissolution of steel; and
recovering the copper precipitated in the previous step with sulfides from the mineral by conventional flotation processes with sulfide collectors.
